(19) United States
(12) Patent Application Publication
(10) Pub. No.: US 2007/0171290 A1
(43) Pub. Date: Jul. 26, 2007

(54) Pixel patterns

(76) Inventor: Ronald Kroger, Lund (SE)

Correspondence Address: HARNESS, DICKEY & PIERCE, P.L.C., P.O. BOX 8910, RESTON, VA, 20195, US

(21) Appl. No.: 10/555,909

(22) PCT Filed: Apr. 30, 2004
(86) PCT No.: PCT/SE04/00662

§ 371 Date: Oct. 31, 2006

(30) Foreign Application Priority Data
May 8, 2003 (SE) 0301330-7

(51) Int. Cl. H04N 9/04

(52) U.S. Cl. 348/272

(57) ABSTRACT

The invention discloses an array of pixels to be arranged in electronic color imaging devices, where the risk of aliasing is reduced by arranging the pixels in the array according to irregular patterns. The array is provided with a first, a second and a third set of pixels representing a first, a second and a third color respectively. The pixels in the first set of pixels and/or the pixels in the second set of pixels are arranged in at least a first spatial frequency, and the pixels in the third set of pixels are arranged in at least a second spatial frequency. In addition, one of said first or second set of pixels may be arranged in at least a third spatial frequency. None of said first, second and third spatial frequencies are harmonics of each other. The array may be implemented in one or several different matrixes of pixels.

### FIELD OF THE INVENTION

The invention relates to electronic imaging devices susceptible to aliasing, where the aliasing is primarily caused by the regularity in which pixels are arranged in image recording or image reproducing arrays used by such devices. Especially, the invention relates to electronic recording and reproduction of colour images.

### BACKGROUND OF THE INVENTION

### INTRODUCTION

In electronic cameras, scanners (including a digital scanner comprised by copying machines, fax machines etc) and in other electronic image-recording devices the image is normally projected or otherwise received on an array of light sensitive elements. Each element translates the received light into an electronic signal, which corresponds to the intensity of the received light. A whole image can therefore be recorded as an array of values received from an array of discrete light sensitive elements, where a specific value corresponds to the light received by a specific element in a specific position in the array. The light sensitive elements can therefore be understood as picture elements—pixels.

Turning for a brief moment to image reproduction, said pixels may be reproduced on a computer screen or on a television screen or by a video projector or a data projector or similar, to create a visible copy of the recorded image. Pixels may then be reproduced having higher or lower intensity, depending on the amount of light originally received by the corresponding light sensitive element. The human eye may perceive the reproduced pixels as black or white or as having different shades of grey, depending on the pixel intensity.

However, if a coloured picture is to be recorded it is not enough to sense the light intensity in the picture. On the contrary, an array of pixels for recording of colour images must also sense colours. The most common principle is to sense the three primary colours: red, green and blue. The three primary colours can reproduce almost all colours and colour hues visible to the human eye. In some applications it may be an alternative to sense the three complementary colours: cyan, magenta and yellow or some other combination of colours.

Three colours can be sensed by three different pixels, e.g. where a first pixel is sensitive to red colour, a second pixel is sensitive to green colour and a third pixel is sensitive to blue colour. The colour sensitivity may e.g. be accomplished by providing an ordinary light sensitive element with a suitable filter for filtering out the red, green or blue components in the light.

In an array of image-recording pixels said three necessary colour sensitive pixels are normally grouped closely together as triplets, where the triplets in turn are arranged closely together. When a recorded colour image is reproduced this nearness between the pixels in a triplet prevents the human eye from distinguishing between the different red, green and blue pixel. Instead the eye will perceive the red, green and blue pixel as one single macro pixel, i.e. the eye will perceive the three pixels added to each other. This makes it possible to reproduce a single macro pixel in any colour visible to a human eye by varying the intensity of the red, green and blue pixel according to the light intensity received by the corresponding red, green and blue light sensitive pixel in the image-recording array. Further, said nearness between the triplets in an array of image-recording pixels prevents the human eye from distinguishing between single triplets when a recorded colour image is reproduced. Instead the human eye will perceive a reproduced image as a homogenous image, despite the fact that the image comprises an array of triplets, each triplet in turn comprising a red, a green and a blue pixel where each pixel may have a varying intensity. Examples of such arrays of pixels are shown in FIG. 1A-1D.

Consequently, the use of a substantial number of triplets enables a reproduction of a recorded image as a homogenous image with different colours having different intensity, including black, white and shades of grey. However, the human eye may actually distinguish between separate sub-pixels or triplets if the colour image is enlarged and/or viewed very closely.

Pixels in an array of pixels are usually packed in an extremely regular pattern, since a regular pattern usually results in the densest possible packing; i.e. the nearness as discussed above. Therefore, as exemplified in FIG. 1A-1D, colour sensitive pixels in an electronic image-recording device are normally arranged in an array of pixels according to a very regular pattern, in which the red, green and blue pixels occur with the same spatial frequencies. The pixels may be arranged at a first spatial frequency in the horizontal direction and at a second frequency in the vertical direction and at a third spatial frequency in some arbitrary diagonal direction. However, the red, green and blue pixels are still arranged at the same spatial frequency in said directions. In other words, the distance between two red pixels is the same as the distance between two green or two blue pixels in said first direction, which is the same in said second and third direction.

Now, if a pattern similar to the recording pixel pattern is present somewhere in an image to be recorded, the image pattern will interact with the pixel pattern to produce a beat pattern, if the image pattern and the pixel pattern have about the same spatial frequency or harmonics thereof. Once a beat pattern has been produced in the recorded image it will also occur in every reproduction of that image. Further, even if no beat pattern is present in a recorded image, a beat pattern will still occur if the image is reproduced by a pixel pattern having about the same spatial frequency as a pattern in the recorded image or harmonics thereof, e.g. if the image is reproduced by a television screen, a data monitor, a video or data projector or similar having such a pixel pattern.

Beat patterns are an unwanted effect or phenomenon known as aliasing and the resulting image is similar or identical to a Moiré pattern of interference (a Moiré beat pattern). Superimposing two similar regular patterns typically generates Moiré beat patterns. For example, superimposing two identical figures comprising simple gratings of alternate black and white bars of equal spacing may generate a Moiré beat pattern. A checkerboard pattern with no Moiré effect is seen when the superimposed figures are crossed at 90°. However, a Moiré pattern of equispaced lines, the Moiré fringes, can be seen at crossing angles of less than 45°, c.f. the example in FIG. 3. The spacing of the fringes increases with decreasing crossing angle. In general, a Moiré pattern is only obtained if the lines of the overlapping figures cross at an angle of less than about 45°.

However, no aliasing will occur if the spatial frequency of every conceivable pattern in an image is lower than any occurring spatial frequency in the pixel pattern in question. This condition is met if the resolution of the pixel pattern is higher than the image resolution. Conversely, the condition is also met if the resolution of the image is lower than the resolution of the pixel pattern concerned.

The resolution of a pixel pattern may be improved by reducing the pixel size. However, there is usually no reason to reduce the size of a pixel much below the limit where a human eye is unable to distinguish one pixel from another when a colour image is reproduced. In addition it is a difficult technical problem to reduce the size of various pixels and it is fair to say that today's technology cannot produce the pixel resolution needed to suit all applications, at least not to an affordable cost. Furthermore, the amount of data needed to electronically represent an image increase to the square of the linear pixel resolution and an increase in the amount of data to be handled demands more computer power, more data memory, faster data communication circuitry etc. In turn, an increase in performance demands more electric power, which is a clear disadvantage in battery powered devices, and it will increase the cost of the electronic components.

Though it may be impossible or unsuitable to improve the resolution of the pixel pattern by reducing the pixel size, aliasing may nevertheless be avoided in many electronic imaging systems by simply reducing the resolution of the image. For example, by reducing the resolution of the lens system projecting the image to be recorded on to the array of light recording pixels in a digital camera. In that case the image resolution should be reduced to be lower than the pixel resolution. However, a high optical resolution in the lens system has the advantage of providing better image contrast, an advantage that should normally be preserved if possible.

Two examples may clarify the discussion above. An image-recording CCD-chip (Charge Coupled Devices) or CMOS (Complementary Metal Oxide Semiconductor) array sensor, commonly used in digital cameras of today, may have a resolution of about 1920×1600 pixels (i.e. totally about 3 million pixels) or slightly more. However, the camera lens system for projecting an image on the camera CCD-chip or similar usually has a substantially higher resolution, which consequently may produce beat patterns in the recorded image, i.e. produce an aliasing phenomenon. Similar, if an image recorded by a digital camera having a 1920×1600 pixel CCD-chip is displayed on a data monitor having 800×600 pixels, this may also produce a beat pattern.

### Prior Art

The patent U.S. Pat. No. 5,899,550 (hereby incorporated by reference) shows a display device in which the sub-colour pixels may be arranged so that, when the respective colour pixels are driven to display an identical gradation level, a ratio of a row-direction line width to a column-direction line width is closer to 1 than the ratio obtained when all the colour pixels have an identical sub-colour pixel arrangement, whereby numerals and characters, for example, can be displayed at an improved display quality.

The patent GB 2 320 790 (hereby incorporated by reference) shows a structure where the pixels are arranged in rows in a first direction, each pixel being made up of three colour filter sub-pixels. The sub-pixels are arranged in a predetermined order RGB in the direction perpendicular to the length of the rows. The pixels in one row are offset by a predetermined distance from the pixels in an adjacent row. The arrangement improves the horizontal direction definition and allows the treatment of curve components.

The documents referred to above do not discuss aliasing phenomena or any solution to overcome such phenomena.

The patent application EP 1 098 535 A1 (hereby incorporated by reference) shows a colour-imaging array of the type having luminance elements of a first colour (typically green) and chrominance elements of second and third colours (typically red and blue). The video signal processing includes, for each element of the second colour, estimating a chrominance value of the third colour as a function of (1) the actual chrominance value of that element, (2) the local neighbourhood of actual chrominance values of the third colour, and (3) an anti aliasing control value derived from the local neighbourhood of actual luminance values and actual colour chrominance values.

In summary, the patent application EP 1 098 535 A1 shows a computerised calculation method for reducing the effects of aliasing. The method is in many respects comparable to a computerised filtering of the image content, which is a common technique for reducing aliasing phenomena in an image.

The patent U.S. Pat. No. 5,461,503 (hereby incorporated by reference) shows a display unit which enables the number of connections to be reduced for a given image quality, or conversely, enabling definition to be increased for a given number of connections. In one embodiment the patent shows a single row made of alternating red, green, blue, green, etc . . . pixels, where the area of each green pixel being substantially half the area of the red and blue pixels, c.f. FIG. 4-7 in the patent.

Said embodiment indicates that an aliasing phenomenon may be mediated by an array of such red, green and blue pixels. However, the spatial frequency of the green pixels is twice the spatial frequency of the red and blue pixels, i.e. the spatial frequency of the red and blue pixels is a harmonic of the spatial frequency of the green pixels. Consequently, an image pattern having the same spatial frequency as the green pixels may form a beat pattern with green pixels as well as with the red and blue pixels. For example, a stripe pattern may have lines showing the same spatial frequency as said green pixels and these lines may therefore interfere with the green pixel pattern. When this happens every second line in the stripe pattern will also interfere with the red and blue pixel patterns. The drawback now described—i.e. that pixels of different types have the same spatial frequency or harmonics thereof—is essentially the same in every row- or column based pattern, for example in such row- or column based patterns as shown in FIG. 4-7 of the now discussed patent U.S. Pat. No. 5,461,503. Moreover, such row- or column based patterns are also shown in FIG. 1B-1D of this document. Furthermore, said drawback is essentially the same in regular hexagonal or triangular pixel patterns as shown in FIG. 1A of this document.

### SUMMARY OF THE INVENTION

As electronic image-recording and electronic image-reproducing devices are susceptible to aliasing, primarily caused by the regularity in which the utilized pixels are arranged, but also caused by low pixel resolution, there is a need for an uncomplicated solution to this problem. Therefore, the present invention discloses a way to minimise aliasing phenomena in electronic imaging devices by providing an array of pixel where the pixels are arranged in patterns that do not easily interact with different patterns in an image. Imaging devices should be understood as comprising both image-recording and image-reproducing devices, unless otherwise is clear from the context or is explicitly stated.

The resolution in an array of pixels is normally maximised if the pixels are packed as densely as possible. Consequently, pixels in an array are usually packed in an extremely regular pattern, since a regular pattern usually results in the densest possible packing. The structure of the densest possible packing depends on the number of different types of pixels in the array. The structure also depends on the relative abundance of differently shaped pixels in the array.

For example, three spectrally different pixels (e.g. a red, a green and a blue pixel) of a circular shape, having equal size and an equal abundance in an array of pixels, can be packed most tightly in a triangular or hexagonal pattern, in which each pixel is preferably surrounded by six pixels of two different types as in FIG. 1A. Alternatively, if said three spectrally different pixels have a rectangular or quadratic shape and equal size and abundance in an array of pixels, they can be packed most tightly in a repeated pattern of adjacent columns or rows, where the column or rows may be vertically or horizontally aligned or displaced in relation to each other as in 1B-1D.

However, despite regular and therefore dense packing of the pixels the resolution in many applications of electronic imaging is still not high enough to avoid aliasing, and then the pixel regularity holds the danger of aliasing. For that reason, one of the underlying ideas of the invention is to provide an electronic imaging array of pixels wherein pixels of different colours are arranged at different spatial frequencies. Especially, pixels of different colours are arranged at different spatial frequencies in at least one direction, e.g. from left to right in the array, and preferably in as many directions as possible and most preferably in every direction. Moreover, said frequencies are to the greatest possible extent non-harmonics of each other.

The effect of the invention may be explained by a schematic example, which is not intended to limit the invention in any way. As already indicated above it is well known that a suitable mix of for example red, green and blue colours can produce almost all colours visible to the human eye, where e.g. yellow is a mix of green and red. A yellow pattern in an image may therefore interfere with the green and red pixel patterns in known pixel arrays. However, according to the present invention a yellow pattern may at the most interfere with one of the green or the red pixel patterns, since the invention provides for a green pixel pattern and a red pixel pattern with different spatial frequencies, which frequencies are non-harmonics. Hence, a possible beat pattern will appear much weaker compared to a beat pattern formed by both the red and the green pixel patterns in combination. This weakening of a possible beat pattern applies for all image patterns having a colour that is composed by a mix of at least two of the red, green and blue colours, provided that the pixel patterns for the red, green and blue colours have different and non-harmonic spatial frequencies.

Nevertheless, a possible occurrence of a beat pattern will not be weakened if the interfering image pattern is composed of a single red, green or blue colour. It is therefore preferred, in addition to arranging pixels of different colours at different spatial frequencies, that pixels of the same colour are irregularly arranged and/or arranged at several spatial frequencies. This will minimise the risk that an image pattern will interfere with the pixel pattern or at least minimise the risk that an image pattern will interfere with all the pixels in the pixel pattern.

Even though the red, green and blue colours have been discussed as an illustrative example above the same conditions are valid for other colour combinations that may be more fitting in certain applications, e.g. the complementary colours cyan, magenta and yellow.

In the light of the above it is preferred that not only pixels of different colours but also pixels having the same colour are arranged according to as many short spatial frequencies as possible, where none or at least as few as possible of the frequencies are harmonics of each other. This makes it less likely that an image pattern will interfere with most or all of the short spatial wavelengths found in the pixel pattern to produce a beat pattern.

Accordingly, the present invention provides for an array of pixels comprising at least a first set of pixels representing a first colour and a second set of pixels representing a second colour and a third set of pixels representing a third colour. The array is characterised in that the pixels in said first set of pixels representing a first colour and/or the pixels in said second set of pixels representing a second colour are arranged in at least a first spatial frequency. Furthermore, the pixels in said third set of pixels representing a third colour are arranged in at least a second spatial frequency. Moreover, an array of pixels according to at least one embodiment of the present invention is characterised in that the pixels in one of said first set of pixels or said second set of pixels are arranged in at least a third spatial frequency.

None of said first, second and third spatial frequency—and in general as few as possible of all the spatial frequencies occurring in an array of pixels—are harmonics of each other, i.e. a frequency should not be an integer value of another frequency. For example, if said first spatial frequency is f cycles/m then said second and third spatial frequencies should not adopt any of the frequencies f/2, f/3, f/4 . . . f/n, or 2f, 3f, 4f . . . nf, where n is an integer value.

It is to be observed that an array of pixels according to the present invention may be arranged in one or several matrixes of pixels.

In one embodiment of the invention the array of pixels is arranged in at least one matrix, wherein at least a subset of said first set of pixels has a first size and at least a subset of said second set of pixels or at least a subset of said third set of pixels has a second size. Moreover, at least some pixels in said single matrix constitute double pixels comprising at least two pixels, where each pixel is selected from one, but not the same, of said first, second or third sets of pixels. Further, at least a first subset of double pixels is arranged in an angle with respect to at least a second subset of double pixels.

Moreover, at least one embodiment of the invention has some pixels in the array that constitutes a double pixel. Each double pixel preferably comprises at least two adjacent pixels selected from two of said first, second or third colours, wherein the first pixel represents a colour which is different from the colour represented by the second pixel. However, a double pixel may have more pixels than two, without departing from the invention. It is preferred that said first and second pixel in a double pixel represents a red and a green colour respectively, though other colours are possible. Furthermore, at least a first subset of said double pixels are arranged in an angle with respect to at least a second subset of said double pixels.

In addition, at least one embodiment of the invention has some double pixels in which the two pixels constitute a coupled pair, where activation of one of the two pixels results in some smaller activation of the other pixel, and vice versa. This will reduce the risk of aliasing, since an image pattern rarely interferes to produce a beat pattern with both pixels as they have different colours. The level of activation may have to be optimised for each particular application. A coupled pair may comprise a red pixel and a green pixel, though other colours are possible.

Further, an array of pixels according to the present invention may be arranged as three separate matrixes of pixels, where the pixels representing a first colour are arranged in a first matrix and the pixels representing a second colour are arranged in second matrix, while the pixels representing a third colour are arranged in third matrix. Moreover, said first matrix is shifted compared to said second matrix and said third matrix, where said shift is accomplished by arranging the matrixes at different angles and/or by arranging the pixels according to different patterns in the different matrixes.

The present invention clearly minimises the effect from possible aliasing phenomena in electronic imaging devices by avoiding regular rows and columns of pixels to the largest possible extent. The irregularity possessed by the pixel patterns according to the present invention has a further advantageous effect in connection with recording and/or reproducing straight and/or curved lines or sharp borders in general. If a line or a sharp border in an image is recorded and/or reproduced by known pixel patterns having regular rows and/or columns similar to those illustrated in FIG. 1A-1D, the line or boarder will be represented in a stair-like manner as schematically illustrated in FIG. 4B. However, this effect will be reduced by the considerably more irregular pixel patterns according to the present invention. The result is schematically illustrated In FIG. 4A, although a thin border having a greyish shade (not illustrated) may occur in the transition region between the black and white area.

### BRIEF DESCRIPTION OF THE DRAWINGS

Preferred embodiments of the present invention will now be described in more detail, with reference to the accompanying drawings, in which:

FIG. 1A shows a known pattern of red, green and blue pixels arranged in a triangular or hexagonal pattern.

FIG. 1B shows a known pattern of red, green and blue pixels arranged in a column or row orientated pattern. The pattern may also be perceived as a triangular or hexagonal pattern.

FIG. 1C shows a known pattern of red, green and blue pixels arranged in a column or row orientated pattern.

FIG. 1D shows a known pattern of red, green and blue pixels arranged in a column or row orientated pattern.

FIG. 2A shows a pattern of red, green and blue pixels arranged in a “square pattern” according to a first embodiment of the present invention.

FIG. 2B shows a pattern of red, green and blue pixels arranged in a “shifted square pattern” according to a second embodiment of the present invention.

FIG. 2C shows a skewed pattern of red, green and blue pixels arranged in a “square pattern” according to a sixth embodiment of the present invention.

FIG. 2D shows a skewed pattern of red, green and blue pixels arranged in a “shifted square pattern” according to a fifth embodiment of the present invention.

FIG. 2E shows a pattern of red, green and blue pixels arranged in a “shifted square pattern” according to a third embodiment of the present invention.

FIG. 2F shows a skewed pattern of red, green and blue pixels arranged in a “shifted square pattern” according to a fourth embodiment of the present invention.

FIG. 3 shows a moiré beat pattern produced by superimposing two identical figures comprising simple gratings of alternate black and white bars of equal spacing.

FIG. 4A shows a schematic figure having the “stair”-phenomena mediated by an irregular arranged array of pixels according to an embodiment of the present invention.

FIG. 4B shows a schematic figure having “stair”-phenomena caused by line and/or boarder interaction with a array of regularly arranged pixels, e.g. according to the pixel arrays in FIG. 1A-1D.

FIG. 5A-5B shows three matrixes of pixels arranged in a similar pattern.

FIG. 6A-6B shows three matrixes of pixels arranged in a similar pattern, where the arrays are arranged at three different angles.

FIG. 7A-7B shows three matrixes of pixels having three different patterns.

### DETAILED DESCRIPTION OF PREFERRED EMBODIMENTS

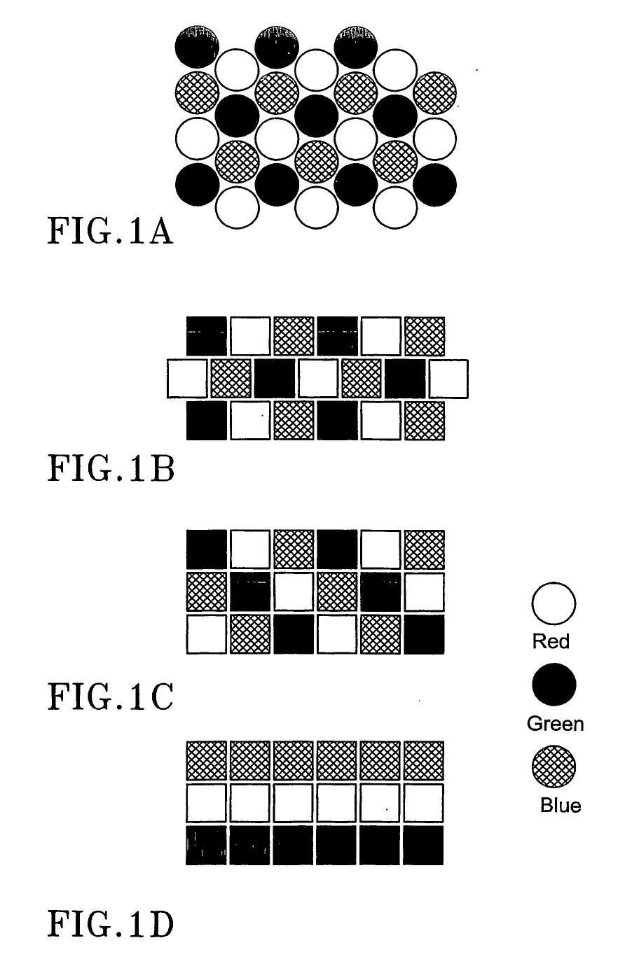

As already mentioned above, in a hexagonal pixel pattern, as shown in FIG. 1A and possibly as shown in FIG. 1B, or in a row- or column aligned pixel pattern as shown in FIG. 1B-1D where the red, green and blue pixels have equal size and shape, are regularly arranged and occurs in a ratio of 1:1:1, an image stripe pattern or other regular image patterns can easily interfere with the pixels to create a beat pattern, i.e. to cause an aliasing phenomena.

Seven embodiments are described below. The first six embodiments are explained in connection with a general array of pixels. However, the embodiments are illustrated by figures showing single matrixes. Therefore it is to be noted that pixels representing different colours can be arranged as one single matrix or as several separated matrixes without departing from the invention. Consequently, the seventh embodiment shows an array of pixels arranged as three separated matrixes, where each matrix comprises pixels of one single colour. However, even if the first six embodiments are illustrated by single matrixes comprising pixels of three different colours and the seventh embodiment shows three matrixes each comprising pixels of one single colour, a matrix may also comprise pixels of two different colours without departing from the invention.

### A First Embodiment

### Square Pattern

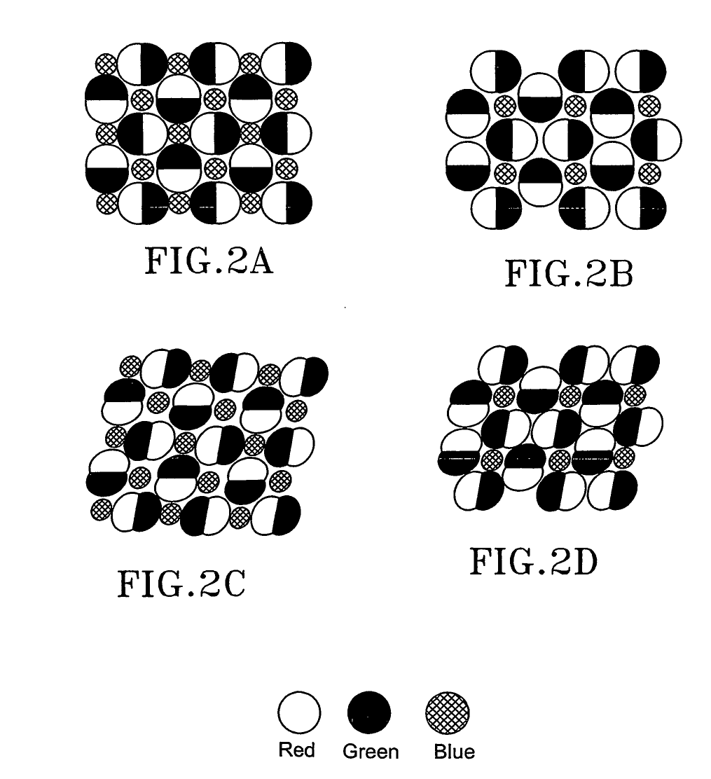

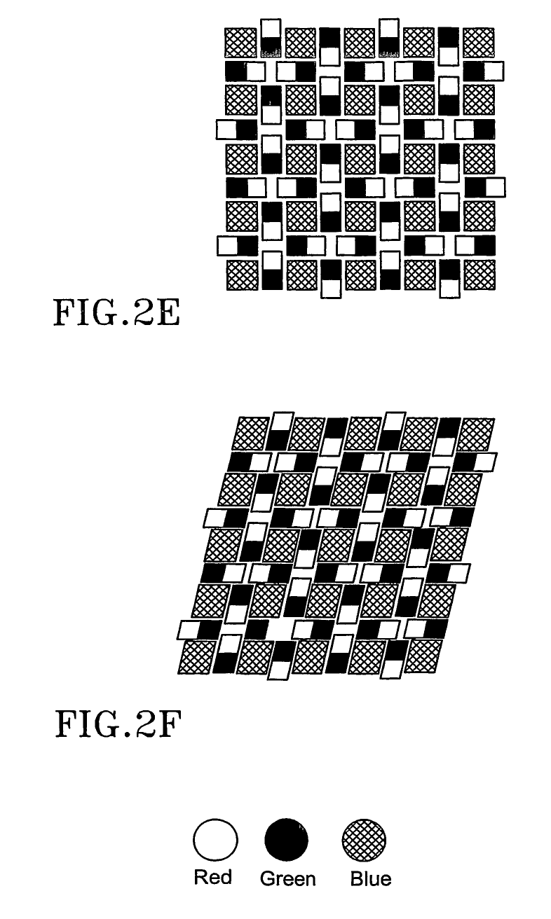

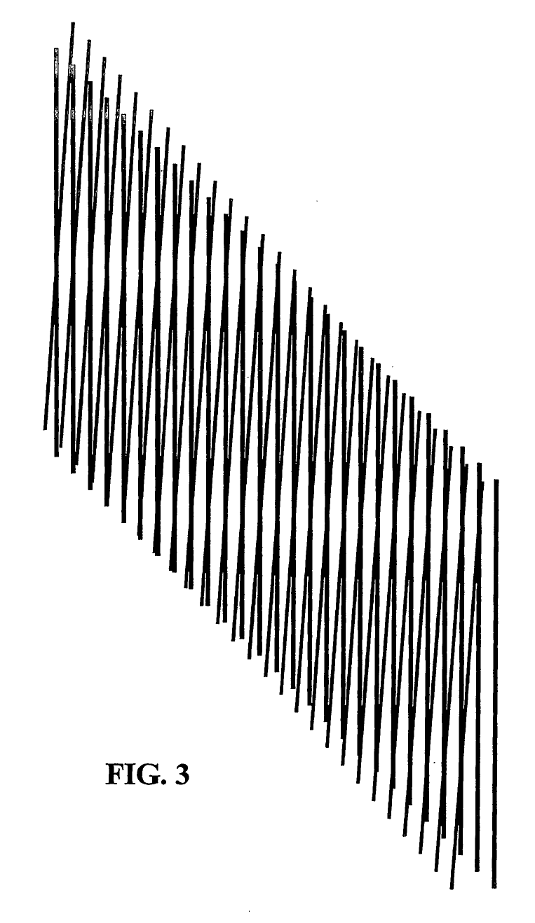

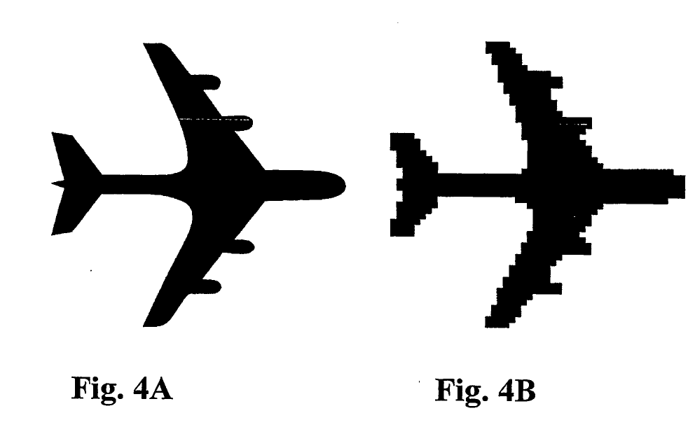

According to a first embodiment of this invention shown in FIG. 2A the risk of such aliasing is reduced. The pixel array illustrated in FIG. 2A is composed of double pixels and single pixels, which occur in about a 1 double:1 single pixel ratio in an array of pixels. It is preferred that the single pixels represent a blue colour, whereas the two pixels in the double pixel represent a red colour and a green colour respectively. Said pixels may in other embodiments represent other colours, depending on the specific application, the surrounding environment etc. An example of other possible colours is the complementary colours cyan, magenta and yellow.

The pixels in the first embodiment are arranged in a “square pattern”, where four double pixels occupy the sides of a square. A first double pixel is horizontally arranged at the bottom of the square, while three further double pixels are preferably arranged at the remaining sides of the square as copies of the first double pixel rotated by approximately 90, 180 and 270 degrees, though other turning angles are possible. In other words, a first and a second double pixel is horizontally arranged at the bottom and at the top of the square respectively, while a third and a fourth double pixels is vertically arranged at the left and at the right side of the square respectively.

Preferably, the top and the bottom double pixels have their respective green and red pixels arranged in opposite directions. In other words, if the bottom double pixel has the green pixel to the left and the red pixel to the right, then the top pixel has its green pixel to the right and its red pixel to the left. Similar, the left and right double pixels preferably have their respective green and red pixels arranged in opposite directions, i.e. if the left double pixel has the green pixel downwards and the red pixel upwards, then the right pixel has the green pixel upwards and the red pixel downwards.

Single preferably blue pixels fill the gaps between the preferably red and green double pixels. One single pixel is arranged between each adjacent pair of horizontally arranged double pixels, and one single pixel is arranged between each adjacent pair of vertically arranged double pixels. This provides an array of pixels wherein a double pixel and one adjacent single pixel may be perceived as a triplet pixel or a macro pixel, comprising a red, a green and a blue pixel.

In this first embodiment all the red and green pixels have about the same first size and about the same first approximately half circular shape, whereas all the blue pixels have about the same second size and about the same second approximately circular shape. As can be seen in FIG. 2A, the blue pixel in this embodiment is smaller than the red and green pixel, which has to be compensated for in many applications. One way of compensating this in a recording electronic imaging device is to increase the sensitivity of the blue pixels compared to the sensitivity of the red and green pixels, whereas one way of compensating this in a reproducing electronic imaging device is to increase the intensity of the blue pixels compared to the intensity of the red and green pixels.

The “square pattern” now described allows the red and green pixel in a double pixel to be arranged more closely to the red and green pixels in other adjacent double pixels, which provides a higher resolution, at least compared to pixel patterns showed in FIG. 1A-1D. Moreover, in the “square pattern” the red pixels and/or the green pixels are arranged in at least a first spatial frequency, and the blue pixels are arranged in at least a second spatial frequency.

Due to the higher resolution a creation of beat patterns in a “square pattern” would demand that the spatial wavelength of an image-pattern, comprising components of red and green colours, is considerably shorter compared to a creation of beat patterns in the patterns shown in FIG. 1A-1D. Further, if a beat pattern nevertheless occurs in a “square pattern” it will not be as articulate as in patterns according to FIG. 1A-1D, since the higher irregularity and associated increase of spatial frequencies in the pixel pattern weakens the beat pattern. To summarize, the higher resolution and the increased number of spatial frequencies reduce the overall risk of aliasing phenomena.

However, the small single and preferably blue pixels in the “square pattern”, may more easily create a beat pattern for longer spatial wavelengths comprising components of a blue colour, since the blue pixels are arranged in a more regular pattern and more spaced apart than the red and green pixels. However, this can be tolerated in many applications, since the spatial resolution of the human eye is considerably lower in the blue range of the spectrum than in the red and green range of the spectrum.

### A Second Embodiment

### Shifted Square Pattern

According to a second embodiment of this invention shown in FIG. 2B the risk of aliasing is reduced in a similar way as in the previously discussed first embodiment of this invention as shown in FIG. 2A.

The pixel array illustrated in FIG. 2B is composed of double pixels and single pixels, which occur in about a 2 double:1 single pixel ratio in an array of pixels. In this embodiment, as In the first embodiment, it is preferred that the single pixels represent a blue colour, whereas the two pixels in the double pixel represent a red colour and a green colour respectively. Said pixels may in other embodiments represent other colours, depending on the specific application, the surrounding environment etc. An example of other possible colours is the complementary colours cyan, magenta and yellow.

The pixels in the second embodiment are arranged in a square pattern where four double pixels occupy the sides of a square, much in a similar way as in the previously discussed first embodiment. Consequently, a first double pixel is horizontally arranged at the bottom of the square, while three further double pixels are preferably arranged at the remaining sides of the square as copies of the first double pixel rotated by approximately 90, 180 and 270 degrees, though other turning angles are possible. In other words, a first and a second double pixel is horizontally arranged at the bottom and at the top of the square respectively, while a third and a fourth double pixels is vertically arranged at the left and at the right side of the square respectively.

Preferably, the top and the bottom double pixels have their respective green and red pixels arranged in opposite directions. In other words, if the bottom double pixel has the green pixel to the left and the red pixel to the right, then the top pixel has its green pixel to the right and its red pixel to the left. Similar, the left and right double pixels preferably have their respective green and red pixels arranged in opposite directions, i.e. if the left double pixel has the green pixel downwards and the red pixel upwards, then the right pixel has the green pixel upwards and the red pixel downwards.

In comparison with the first embodiment, however, the double pixels in this second embodiment have been shifted to the corners of the squares, which creates a “shifted square pattern”. This “shifted square pattern” results in a slightly denser packing of the pixels compared to the “square pattern” in the previously discussed first embodiment, since the gaps at the corners of the squares have been filled by the shifted double pixels.

Further, the “shifted square pattern” causes a uniform gap within each square, which gap is large enough to encompass the smaller single blue pixel. Single preferably blue pixels fill these gaps between the preferably red and green double pixels. Thus, according to this second embodiment there is only one single blue pixel arranged in the middle of every square. This provides an array of pixels wherein two double pixels and an adjacent single pixel may be perceived as an extended triplet pixel or an extended macro pixel, comprising two red pixels, two green pixels and one blue pixel. The designation triplet pixel and macro pixel are motivated, even if more than three pixels are involved, since there are still only three colours.

In this second embodiment, as in first embodiment, all the red and green pixels have about the same first size and about the same first approximately half circular shape, whereas all the blue pixels have about the same second size and a about the same second approximately circular shape. As can be seen in FIG. 2B, the blue pixel in this embodiment is smaller than the red and green pixels, which has to be compensated for in many applications. Further, the number of blue pixels is about half the number of red and green pixels, which also has to be compensated for in many applications. One way of compensating this in a recording electronic imaging device is to increase the sensitivity of the blue pixels compared to the sensitivity of the red and green pixels, whereas one way of compensating this in a reproducing electronic image device is to increase the intensity of the blue pixels compared to the intensity of the red and green pixels. Compensation could also be achieved by adjusting the relative size of the pixels.

The “shifted square pattern” now described shows a pixel pattern wherein the distance between the double pixels comprising a red and a green pixel are almost at maximum, while at the same time providing almost the densest possible packing. This offers a somewhat higher resolution than any pixel resolution in the regular “square pattern” according to the first embodiment described above, especially for pixels representing a green colour, i.e. the black pixels in FIG. 2B. In particular it offers notably higher resolution than any pixel pattern shown in FIG. 1A-D. Moreover, similar as in the “square pattern” described above, the red, green and blue pixels in the “shifted square pattern” are arranged in at least a first, at least a second and at least a third spatial frequency, respectively. In general, the green colour should be allocated the highest resolution, since the human eye has its highest resolution and sensitivity in the green range of the visible spectrum.

Due to the higher resolution a creation of beat patterns in a “shifted square pattern” would demand that the spatial wavelength of an image-pattern, comprising components of red and green colours, is considerably shorter compared to a creation of beat patterns in the pixel patterns shown in FIG. 1A-1D. If a beat pattern nevertheless occurs in a “shifted square pattern”, it will not be as articulate as in the patterns according to FIG. 1A-1D, since the higher irregularity and the associated increase in the number of spatial frequencies in the pixel pattern weakens the beat pattern. To summarize, the higher resolution and the increased number of spatial frequencies reduce the overall risk of aliasing phenomena.

However, similar as in the “square pattern” described above, the small single and preferably blue pixels in the “shifted square pattern” may more easily create a beat pattern for longer spatial wavelengths comprising components of a blue colour, since the blue pixels are arranged in a more regular pattern and are more spaced apart than the red and green pixels. However, as in the “square pattern” this can be tolerated in many applications, since the spatial resolution of the human eye is considerably lower in the blue range of the spectrum than in the red and green ranges of the spectrum.

In addition, pixels representing a green colour in the “shifted square pattern” may be slightly more regularly arranged than the corresponding green pixels in the “square pattern” as discussed above. The green pixels in the “shifted square pattern” may therefore form a beat pattern more easily with an image pattern comprising a green colour, having a similar spatial wavelength. At the same time, the risk of any aliasing is mediated due to the higher resolution in the green pixel pattern.

Moreover, in the “shifted square pattern” the pixels representing a red colour touch pixels of the same type at the corners of the squares. Spots of light can easily overlap on both of the touching pixels so that the position of the received light spot is less well known. Similarly, in a reproducing electronic imaging device the human eye may perceive the touching red pixels as one single red pixel, which increases the coarseness, i.e. reduces the resolution for the red pixels. However, this can be tolerated in many applications, since the spatial resolution of the human eye is lower in the red range of the spectrum than in the green range of the spectrum. In addition, the red pixels in a “shifted square pattern” can be arranged to have a higher resolution than comparable red pixels in patterns as shown in FIG. 1A-1D.

### A Third Embodiment

### Shifted Square Pattern

According to a third embodiment of this invention shown in FIG. 2E the risk of aliasing is reduced in a similar way as in the previously discussed second embodiment of this invention as shown in FIG. 2B.

In the third embodiment, as in the second embodiment, the pixel array illustrated in FIG. 2E is composed of double pixels and single pixels, which occur in about a 2 double:1 single pixel ratio in an array of pixels. In this embodiment, as in the second embodiment, it is preferred that the single pixels represent a blue colour, whereas the two pixels in the double pixel represent a red colour and a green colour respectively.

The pixels in the third embodiment are arranged in a “shifted square pattern” where four double pixels occupy the sides of a square in a similar way as in the previously discussed second embodiment. Consequently, a first double pixel is horizontally arranged at the bottom of the square, while three further double pixels are preferably arranged at the remaining sides of the square as copies of the first double pixel rotated by approximately 90, 180 and 270 degrees, though other turning angles are possible. In other words, a first and a second double pixel is horizontally arranged at the bottom and at the top of the square respectively, while a third and a fourth double pixels is vertically arranged at the left and at the right side of the square respectively.

Preferably, the top and the bottom double pixels have their respective green and red pixels arranged in opposite directions. In other words, if the bottom double pixel has the green pixel to the left and the red pixel to the right, then the top pixel has its green pixel to the right and its red pixel to the left. Similar, the left and right double pixels preferably have their respective green and red pixels arranged in opposite directions, i.e. if the left double pixel has the green pixel downwards and the red pixel upwards, then the right pixel has the green pixel upwards and the red pixel downwards.

In the third embodiment all red, green and blue pixels have about the same quadratic like shape. All red and green pixels have about the same first size. However, as can be seen in FIG. 2E, all blue pixels in this embodiment have a second larger size. Actually it is preferred that the blue pixels are about twice the size of the red and green pixels, which means that all spectral types of pixel can have the same total surface area, since the blue pixels are about half as many as the red and green pixels. If that is not the case, compensation may be necessary in many applications. Possible compensating methods have been exemplified in connection with the first and second embodiments of this invention.

Other properties of the third embodiment are similar to the properties of the second embodiment and the above discussion regarding the second embodiment is applicable mutatis mutandis to the third embodiment.

### A Fourth Embodiment

### Skewed Shifted Square Pattern

According to a fourth embodiment of this invention shown in FIG. 2F the risk of aliasing is reduced in a similar way as in the previously discussed third embodiment of this invention as shown in FIG. 2B and FIG. 2E.

The pixels in this fourth embodiment are substantially the same as in the third embodiment shown in FIG. 2E. This means that the fourth embodiment i.a. represents a “shifted square pattern” where four double pixels occupy the sides of a square in a similar way as in the previously discussed third embodiment. Consequently, a first double pixel is horizontally arranged at the bottom of the square. Three further double pixels are preferably placed at the remaining three sides of the square as copies of the first double. However, these three double pixels are rotated approximately 80, 180 and 260 degrees, though other turning angles are possible.

Further, in the fourth embodiment all red, green and blue pixels have about the same rhombic like shape, though other non-rhombic shapes are also possible. All red and green pixels have about the same first size. However, as can be seen in FIG. 2F, all blue pixels in this embodiment have a second larger size. Actually it is preferred that the blue pixels are about twice the size of the red and green pixels, which means that all spectral types of pixel can have the same total surface area, since the blue pixels are about half as many as the red and green pixels. If that is not the case, compensation may be necessary in many applications. Possible compensating methods have been exemplified in connection with the first and second embodiments of this invention.

As can be seen in FIG. 2F the pixel pattern has been slightly skewed compared to the pixel pattern in the third embodiment as shown in FIG. 2E. Such a skewing implies that the number of spatial wavelengths close to the upper limit of resolution is increased, since the diagonals of the “squares” are different in lengths. In other words, the incorporation of many high spatial frequencies into the array of pixel patterns has been carried even further in the fourth embodiment. Consequently, aliasing will be even more unlikely for most pattern orientations in an image.

Other properties of the fourth embodiment are similar to the properties of the second and the third embodiment and the above discussion regarding the second and third embodiment is therefore applicable mutatis mutandis to the fourth embodiment.

### A Fifth Embodiment

### Skewed Shifted Square Pattern

According to a fifth embodiment of this invention shown in FIG. 2D the risk of aliasing is reduced in a similar way as in the previously discussed second embodiment of this invention as shown in FIG. 2B.

In the fifth embodiment, as in the second embodiment, the pixel array illustrated in FIG. 2D is composed of double pixels and single pixels, which occur in about a 2 double:1 single pixel ratio in an array of pixels. In this embodiment, as in the second embodiment, it is preferred that the single pixels represent a blue colour, whereas the two pixels in the double pixel represent a red colour and a green colour respectively.

The pixels in the fifth embodiment are arranged in a “shifted square pattern”, where four double pixels occupy the sides of a square in a similar way as in the previously discussed second embodiment. Consequently, a first double pixel is horizontally arranged at the bottom of the square. Three further double pixels are preferably arranged at the remaining sides of the square as copies of the first double pixel. However, these three double pixels are rotated by approximately 80, 180 and 260 degrees, though other turning angles are possible.

Consequently, as can be seen in FIG. 2D the pixel pattern has been slightly skewed compared to the pixel pattern in the second embodiment as shown in FIG. 2B. Such a skewing implies that the number of spatial wavelengths close to the upper limit of resolution is increased, since the diagonals of the “squares” are different in lengths. In other words, the incorporation of many high spatial frequencies into the array of pixel patterns has been carried even further in the fourth embodiment. Consequently, aliasing will be even more unlikely for most pattern orientations in an image.

Other properties of the fifth embodiment are similar to the properties of the second embodiment and the above discussion regarding the second embodiment is applicable mutatis mutandis to the third embodiment.

### A Sixth Embodiment

### Skewed Square Pattern

According to a sixth embodiment of this invention shown in FIG. 2C the risk of aliasing is reduced in a similar way as in the previously discussed first embodiment of this invention as shown in FIG. 2A.

In the sixth embodiment, as in the first embodiment, the pixel array illustrated in FIG. 2C is composed of double pixels and single pixels, which occur in about a 1 double:1 single pixel ratio in an array of pixels. In this embodiment, as in the first embodiment, it is preferred that the single pixels represent a blue colour, whereas the two pixels in the double pixel represent a red colour and a green colour respectively.

The pixels in the sixth embodiment, as in the first embodiment, are arranged in a “square pattern”, where four double pixels occupy the sides of a square. A first double pixel is horizontally arranged at the bottom of the square. Three further double pixels are preferably arranged at the remaining sides of the square as copies of the first double pixel. However, these three double pixels are rotated by approximately 80, 180 and 260 degrees, though other turning angles are possible.

Consequently, as can be seen in FIG. 2C the pixel pattern has been slightly skewed compared to the pixel pattern in the first embodiment as shown in FIG. 2A. Such a skewing implies that the number of spatial wavelengths close to the upper limit of resolution is increased, since the diagonals of the “squares” are different in lengths. In other words, the incorporation of many high spatial frequencies into the array of pixel patterns has been carried even further in the fourth embodiment. Consequently, aliasing will be even more unlikely for most pattern orientations in an image.

Other properties of the sixth embodiment are similar to the properties of the first embodiment and the above discussion regarding the first embodiment is applicable mutatis mutandis to the third embodiment.

### A Seventh Embodiment

### Three Different Matrixes

Colour images may be recorded and/or reproduced by using an array of pixels distributed on three separate matrixes of pixels. For example, in digital cameras and other electronic image-recording devices, different ranges of the spectrum of light can be optically separated and detected with several matrixes of pixels, typically one matrix of pixels for a red colour, one for a green colour and one for a blue colour. Likewise, in e.g. video projectors and other electronic image-reproducing devices, an image can be generated by optically combining separate colour channels each using a matrix of pixels, typically one channel for a red colour, one for a green colour and one for a blue colour.

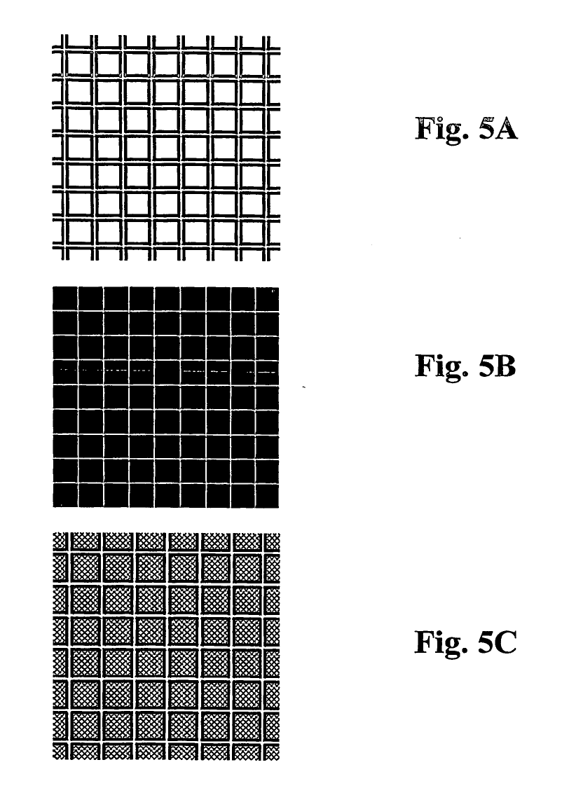

Multi channel devices as briefly described above are also susceptible to aliasing phenomena, if the pixels in the three matrixes are regularly arranged. An example of three regularly arranged matrixes of pixels is shown in FIG. 5A-5C. FIG. 5A illustrates a first matrix of pixels representing a red colour, FIG. 5B illustrates a second matrix of pixels representing a green colour and FIG. 5C illustrates a third matrix of pixels representing a blue colour. As can be seen in FIG. 5A-5C, all three matrixes have their pixels arranged according to a nearly identical rectangular pattern, which means that a rectangular or a linear image pattern having about the same spatial frequency as the pixel patterns or harmonics thereof can interfere with all the pixel patterns simultaneously to produce a beat pattern, i.e. an aliasing phenomena.

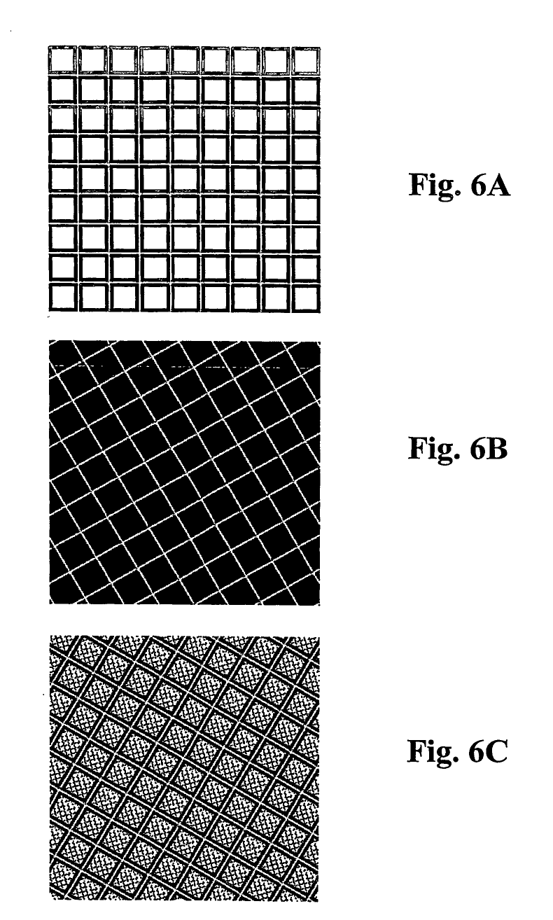

However, the effect of an aliasing phenomena can be reduced by having the pixel rows in the three matrixes oriented at different angles, as exemplified in FIG. 6A-6C. Here, FIG. 6A illustrates a first matrix of pixels arranged at a first angle and preferably representing a red colour, where FIG. 6B illustrates a second matrix of pixels arranged at a second angle and preferably representing a green colour, where FIG. 6C illustrates a third matrix of pixels arranged at a third angle and preferably representing a blue colour. However, other colours are possible. Now, if an image pattern does interfere with the pixel pattern in one matrix in such an angle-shifted arrangement it will probably not interfere with the pixel pattern in the other matrixes. Obviously, this reduces the effect of possible aliasing phenomena, at least when the image pattern is composed by more than one colour.

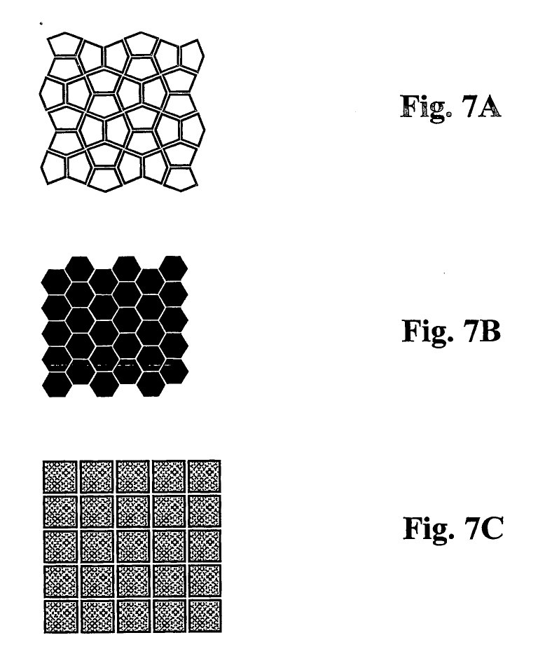

Another way is to arrange the pixels in different patterns (e.g. hexagonal, pentagonal, square pixels etc), which implies that the pixels in the three matrixes can be arranged according to different spatial frequencies. This is exemplified in FIG. 7A-7C, where FIG. 7A illustrates a first matrix of pixels arranged according to a first pattern and preferably representing a red colour, where FIG. 7B illustrates a second matrix of pixels arranged according to a second pattern and preferably representing a green colour, where FIG. 7C illustrates a third matrix of pixels arranged according to a third pattern and preferably representing a blue colour. However, other colours are possible. In a similar way as in FIG. 6A-6C, if an image pattern does interfere with one of the pixel patterns in such a pattern-shifted arrangement it will probably not interfere with the pixel pattern in the other matrixes. Obviously, this reduces the effect of possible aliasing phenomena, at least when the image pattern is composed by more than one colour.

Pattern-shifting can e.g. be obtained by using different patterns in the three matrixes, e.g. a square pattern in the first matrix, a hexagonal pattern in the second matrix, where the third matrix may have any of the patterns assigned to the pixels having a red, green or blue colour in the six previously described embodiments (c.f. FIG. 2A-2F). More particularly, a pattern-shifting can e.g. be obtained by using pixels of different sizes in the pixel matrixes, e.g. a first size in a first matrix, a second size in a second matrix and a third size in a third matrix. This implies that the pixels in the three matrixes can be arranged according to different spatial frequencies, which minimises the risk for aliasing phenomena. The same effect—i.e. arranging the pixels in the three matrix according to different spatial frequencies—can be obtained by using pixels of different shapes, where said shapes e.g. is similar to a circle, sector of a circle, segment of a circle, half-circle, ellipse, segment of a parabola, triangle, quadrate, rhomb, trapezoid, pentagon, hexagon, octagon etc (compare e.g. FIG. 7A and 7C). Moreover, a matrix of pixels may have pixels of both a different shape and a different size compared to the pixels in another matrix.

Angle shifting and pattern shifting, as discussed above, can be combined in a manner suitable for the specific electronic imaging application. For example, pixels in a first matrix of pixels may be arranged both at a different angle and in a different pattern compared to the pixels in any other matrix.

The present invention has now been described in the light of exemplary embodiments. However, the invention should not be considered as limited to these embodiments. On the contrary, the invention includes all possible variations covered by the scope defined by the appended claims.

1. An array of pixels, wherein at least a first set of pixels represents a first colour, a second set of pixels represents a second colour and a third set of pixels represents a third colour,
wherein:
the pixels in at least one of said first set of pixels representing a first colour or said second set of pixels representing a second colour are arranged in at least a first spatial frequency;
the pixels in said third set of pixels representing a third colour are arranged in at least a second spatial frequency;
none of said first and said at second frequencies are harmonics of each other.

2. An array of pixels according to claim 1,
wherein:
the pixels in one of said first set of pixels or said second set of pixels are arranged in at least a third spatial frequency, where none of said first, second or third frequencies are harmonics of each other.

3. An array of pixels according to claim 1, where said pixels are arranged in at least one matrix of pixels, wherein at least a subset of said first set of pixels has a first size, and at least a subset of said second set of pixels or at least a subset of said third set of pixels has a second size,
wherein:
at least some pixels constitute double pixels comprising at least two pixels, where each pixel 4 is selected from one, but not the same, of said first, second or third sets of pixels;
at least a first subset of double pixels is arranged in an angle with respect to at least a second subset of double pixels.

4. An array of pixels according to claim 3
wherein;
at least a subset of said second set of pixels or least a subset of said third set of pixel has a third size.

5. An array of pixels according to claim 3
wherein:
pixels in said first, second or third sets of pixels occur in a substantially equal quantity.

6. An array of pixels according to claim 3
wherein:
pixels in two of said first, second or third sets of pixels occur in a substantially equal first quantity, whereas pixels in the remaining of said first, second or third sets of pixels occur in a second higher or lower quantity.

7. An array of pixels according to claim 3
wherein:
pixels in said first set, second and third sets of pixels occur in a first, a second and a third quantity respectively, where each single quantity differs from the two other.

8. An array of pixels according to claim 3
wherein:
the array is skewed.

9. An array of pixels according to claim 3
wherein:
activation of the first pixel in a double pixel leads to some activation of the second pixel in the double pixel.

10. An array of pixels according to claim 1
wherein:
at least a subset of one of said first, second or third sets of pixels has a first shape and at least a subset of another of said first, second or third set of pixels has a second shape.

11. An array of pixels according to claim 10
wherein:
at least a subset of any of said first, second or third sets of pixels has a third shape.

12. An array of pixels according to claim 10
wherein:
at least one of said first, second and third shape is similar to at least one of a circle, sector of a circle, segment of a circle, half-circle, ellipse, segment of a parabola, triangle, quadrate, rhomb, trapezoid, pentagon, hexagon, octagon.

13. An array of pixels according to claim 1, where said pixels are arranged in three separate matrixes of pixels, where
the pixels representing a first colour are arranged in a first matrix,
the pixels representing a second colour are arranged in second matrix,
the pixels representing a third colour are arranged in third matrix,
wherein:
said first matrix is shifted compared to said second matrix and said third matrix.

14. An array of pixels according to claim 13
wherein:
said second matrix and said third matrix is shifted compared to each other.

15. An array of pixels according to claim 13
wherein:
said shifting is accomplished in that said first matrix is arranged at a first angle, and one of said second matrix or said third matrix is arranged at a second angle.

16. An array of pixels according to claim 15
wherein:
one of said second matrix or said third matrix is arranged at a third angle.

17. An array of pixels according to claim 13
wherein:
said shifting is accomplished by said first matrix having pixels arranged in a first pattern and one of said second matrix or said third matrix having pixels arranged in a second pattern.

18. An array of pixels according to claim 17
wherein:
one of said second matrix or said third matrix having pixels arranged in a third pattern.

19. An array of pixels according to claim 1,
wherein:
said first colour is a red colour, said second colour is a green colour and said third colour is a blue colour.

20. An electronic imaging device comprising an array of pixels according to claim 1.

21. An electronic imaging device according to claim 20
wherein:
the device is an electronic camera, an image scanner, a data monitor, a television monitor, a video projector, a data projector or a photocopying machine.
